(19) United States
(12) Patent Application Publication
(10) Pub. No.: US 2022/0335016 A1
(43) Pub. Date: Oct. 20, 2022

(54) MANAGEMENT DEVICE, MANAGEMENT METHOD, AND NON-TRANSITORY COMPUTER-READABLE RECORDING MEDIUM

(71) Applicant: Mitsubishi Electric Corporation, Tokyo (JP)

(72) Inventors: Hikaru SATO, Tokyo (JP); Masaya HONJO, Tokyo (JP)

(73) Assignee: Mitsubishi Electric Corporation, Tokyo (JP)

(21) Appl. No.: 17/857,433

(22) Filed: Jul. 5, 2022

Related U.S. Application Data
(63) Continuation of application No. PCT/JP2020/009177, filed on Mar. 4, 2020.

(51) Int. Cl. G06F 16/18; G06F 16/182

(52) U.S. Cl. CPC G06F 16/1805; G06F 16/182; G06F 16/137

(57) ABSTRACT

A management device (100) includes a ledger management unit (110) and a control unit (140). Ledger status information including a ledger status is recorded in the ledger management unit (110). The ledger status indicates control restriction corresponding to an individual one of at least one distributed ledger which records distributed electronic data and to which control restriction is applied. The control unit (140) controls an individual one of at least one distributed ledger in accordance with the ledger status corresponding to the individual one of said at least one distributed ledger.

### CROSS REFERENCE TO RELATED APPLICATIONS

This application is a Continuation of PCT International Application No. PCT/JP2020/009177 filed on Mar. 4, 2020, which is hereby expressly incorporated by reference into the present application.

### TECHNICAL FIELD

The present disclosure relates to a management device, a management method, and a management program.

### BACKGROUND ART

A distributed ledger is a technology for sharing data by using a plurality of servers and the like. In the distributed ledger, the plurality of servers and the like hold information concerning all past data operations. Specific examples of the data operations are to register data in the distributed ledger and to update data registered in the distributed ledger. One of the main features of the distributed ledger is that it enables a plurality of servers to easily monitor data tampering and the like of each other.

A blockchain is an example of the distributed ledger. The blockchain creates blocks and keeps data in a chronological order. A block is a unit of data. Each block contains information that connects a preceding block and a following block to each other.

When a content of a certain block is changed, contents of all the blocks following the changed block must be changed. Therefore, it is difficult to change or delete data once recorded in the past block. This leads to high tamper resistance of the blockchain.

The blockchain needs to store all past data so that the data is verified. Storage usage in the blockchain increases linearly. Hence, when the blockchain is operated for a long period of time, the storage usage will become enormous.

Patent Literature 1 discloses a technique of setting an expiration day and time in a smart contract and disabling recording of data to a blockchain linked to a smart contract whose expiration day and time have passed. According to this technique, the storage usage can be reduced by deleting a blockchain that cannot perform recording any more.

### CITATION LIST

### Patent Literature

Patent Literature 1: JP 2019-008791 A

### SUMMARY OF INVENTION

### Technical Problem

Patent Literature 1 discloses methods of deleting a blockchain when an operation of a smart contract linked to the blockchain is ended, thereby reducing data. According to these methods, the data of the blockchain corresponding to the smart contract cannot be reduced until the operation of the smart contract is ended.

In view of this, it may be possible to identify a blockchain whose operation is ended, by managing a state of the blockchain. However, depending on the methods of Patent Literature 1, the state of the blockchain cannot be grasped, and accordingly an unnecessary blockchain cannot be identified.

An objective of the present disclosure is to manage a distributed ledger in a manner to be associated with a status of the distributed ledger.

### Solution to Problem

A management device according to the present disclosure includes:

a ledger management unit in which ledger status information including a ledger status is recorded, the ledger status indicating control restriction corresponding to an individual one of at least one distributed ledger which records distributed electronic data and to which control restriction is applied; and

a control unit to control an individual one of said at least one distributed ledger in accordance with the ledger status corresponding to an individual one of said at least one distributed ledger.

### Advantageous Effects of Invention

A management device includes a ledger management unit and a control unit. Ledger status information including a ledger status is recorded in the ledger management unit. The ledger status indicates control restriction corresponding to an individual one of at least one distributed ledger which records distributed electronic data and to which control restriction is applied. The control unit controls an individual one of at least one distributed ledger in accordance with the ledger status corresponding to the individual one of the at least one distributed ledger. The ledger status corresponds to a state of the distributed ledger.

Therefore, according to the present disclosure, the distributed ledger can be managed in a manner to be associated with the state of the distributed ledger.

### BRIEF DESCRIPTION OF DRAWINGS

FIG. 1 illustrates a configuration example of a management system 90 according to Embodiment 1.

FIG. 2 illustrates a hardware configuration example of the management system 90 according to Embodiment 1.

FIG. 3 illustrates a software configuration example of the management system 90 according to Embodiment 1.

FIG. 4 illustrates a configuration example of a ledger management unit 110 according to Embodiment 1.

FIG. 5 illustrates a configuration example of a selection unit 120 according to Embodiment 1.

FIG. 6 illustrates a software configuration example of the management system 90 according to Embodiment 1.

FIG. 7 illustrates a configuration example of the management system 90 according to Embodiment 1.

FIG. 8 is a flowchart illustrating a status setting process according to Embodiment 1.

FIG. 9 is a flowchart illustrating a selection rule setting process according to Embodiment 1.

FIG. 10 is a flowchart illustrating a status auto-update process according to Embodiment 1.

FIG. 11 is a flowchart illustrating a new data registration process according to Embodiment 1.

FIG. 12 is a flowchart illustrating an update data registration process according to Embodiment 1.

FIG. 13 is a flowchart illustrating a data reference process according to Embodiment 1.

FIG. 14 is a flowchart illustrating a ledger delete process according to Embodiment 1.

FIG. 15 is a configuration example of a management device 100 according to a modification of Embodiment 1.

### DESCRIPTION OF EMBODIMENTS

In description of the embodiment and drawings, the same elements and the equivalent elements are denoted by the same reference sign. Explanations of elements denoted by the same reference sign will be appropriately omitted or simplified. An arrow in the drawings mainly expresses a data flow or a process flow.

### Embodiment 1

A present embodiment will be described in detail with referring to drawings.

Description of Configurations

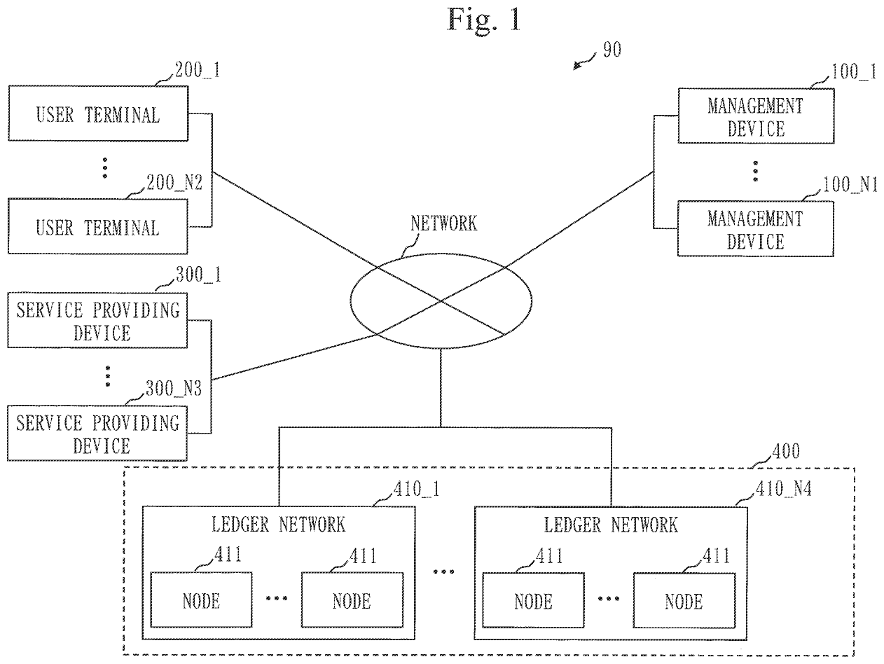

FIG. 1 illustrates a configuration example of a management system 90 according to the present embodiment. The management system 90 is provided with a management device 100, a user terminal 200, a service providing device 300, and a ledger network group 400. The ledger network group 400 is provided with one or more ledger networks 410.

As illustrated in FIG. 1, the management system 90 may be provided with a plurality of management devices 100, a plurality of user terminals 200, a plurality of service providing devices 300, and a plurality of ledger networks 410. Representations “management device 100_1” and “management device 100_N” in FIG. 1 are employed to enable distinction among the plurality of management devices 100. The same representation as for the management device 100 is employed for the user terminals 200, the service providing devices 300, and the ledger networks 410. Note that N1, N2, N3, and N4 are each an integer of 2 or more.

The management device 100, the user terminal 200, the service providing device 300, and the ledger network 410 are connected to each other via a network. A specific example of the network is the Internet or an internet; or a combination of the Internet and an intranet. Not all components of the management system 90 need to be connected to each other.

The ledger network 410 is constituted of one or more nodes 411. When the ledger network 410 is constituted of a plurality of nodes 411, the plurality of nodes 411 are connected to each other via the network.

The management device 100 manages one or more ledger networks 410. In a specific example, the management device 100 records data on the distributed ledger, refers to data on the distributed ledger, deletes data on the distributed ledger, or sets an operation method of the distributed ledger, in response to a request from the user terminal 200 via the service providing device 300. How to operate the distributed ledger may be indicated in a ledger status. The ledger status is information indicating a state of the distributed ledger. The ledger status indicates control restriction of the distributed ledger.

The user terminal 200 is a terminal used by a user when accessing the distributed ledger. The user is an agent who uses the distributed ledger, unless otherwise noted. The user need not be a person but can be, for example, a computer.

The service providing device 300 is a server that provides a service to the user. The service relates to use of the distributed ledger as a data storage area. In a specific example, a business application or a Web application is used to provide the service. The application signifies an application program unless otherwise noted.

The ledger network 410 is a network provided with one or more nodes 411. The node 411 operates the distributed ledger. One node 411 may operate a plurality of distributed ledgers. The distributed ledger records distributed electronic data. Control restriction is applied to the distributed ledger. The control restriction indicates restriction for the user to control the distributed ledger. The electronic data may be distributed in any manner.

In a specific example where there is no user or no service is provided to the user, the management system 90 need not be provided with any user terminal 200 nor any service providing device 300.

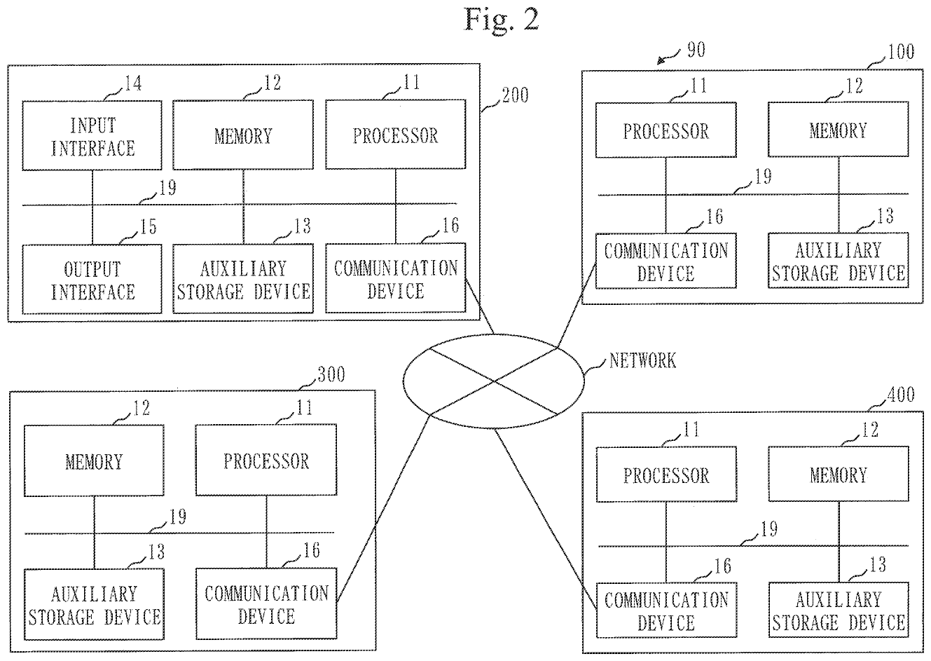

FIG. 2 illustrates a hardware configuration example of the management system 90 according to the present embodiment. In this example, the management system 90 is provided with one management device 100, one user terminal 200, one service providing device 300, and one ledger network 410. The ledger network 410 is constituted of one node.

The management device 100 is typically formed of a computer. The management device 100 may be formed of a plurality of computers.

The management device 100 is provided with hardware devices such as a processor 11, a memory 12, an auxiliary storage device 13, and a communication device 16. These hardware devices are connected to each other via a signal line 19.

The processor 11 is an Integrated Circuit (IC) that performs a computation process, and controls the hardware devices provided to the computer. A specific example of the processor 11 is a Central Processing Unit (CPU), a Digital Signal Processor (DSP), or a Graphics Processing Unit (GPU).

The management device 100 may be provided with a plurality of processors that replace the processor 11. The plurality of processors share roles of the processor 11.

The memory 12 is typically a volatile storage device. The memory 12 is also called a main storage device or a main memory. A specific example of the memory 12 is a Random-Access Memory (RAM). Data stored in the memory 12 is saved in the auxiliary storage device 13 as necessary.

The auxiliary storage device 13 is typically a non-volatile storage device. A specific example of the auxiliary storage device 13 is a Read-Only Memory (ROM), a Hard Disk Drive (HDD), or a flash memory. Data stored in the auxiliary storage device 13 is loaded to the memory 12 as necessary.

The memory 12 and the auxiliary storage device 13 may be formed integrally.

The communication device 16 is a receiver/transmitter. A specific example of the communication device 16 is a communication chip or a Network Interface Card (NIC).

Individual units in the management device 100 may use the communication device 16 when communicating with another device or the like.

A management program is stored in the auxiliary storage device 13. The management program is a program that causes the computer to implement functions of the individual units provided to the management device 100. The management program may be composed of a plurality of files. The management program is loaded to the memory 12 and run by the processor 11. The functions of the individual units provided to the management device 100 are implemented by software.

When the individual units in the management device 100 transmit and receive data, the individual units in the management device 100 use data via the communication device 16.

Data used when running the management program and data obtained by running the management program are stored as necessary in a storage device provided to the management device 100. In a specific example, the storage device provided to the management device 100 is formed at least one of a memory 12, an auxiliary storage device 13, a register in the processor 11, and a cache memory in the processor 11. In the present specification, data and information may have the same meaning.

The function of the memory 12 and the function of the auxiliary storage device 13 may be each implemented by one or more storage devices.

Any program described in the present specification may be recorded on a computer-readable non-volatile recording medium. A specific example of the non-volatile recording medium is an optical disk or a flash memory. Any program described in the present specification may be provided in the form of a program product.

A configuration of the service providing device 300 is similar to the configuration of the management device 100. A service providing program is stored in the service providing device 300 in place of a management program.

A configuration of the node 411 is similar to the configuration of the management device 100. A ledger program is stored in the ledger network 410 in place of a management program.

The user terminal 200 is provided with a processor 11, a memory 12, an auxiliary storage device 13, an input interface 14, an output interface 15, and a communication device 16.

The input interface 14 is a port to which an input device is connected. A specific example of the input device is a device such as a key board and a mouse, that operates the management device 100. A specific example of the input interface 14 is a Universal Serial Bus (USB) terminal.

The output interface 15 is a port to which an output device is connected. A specific example of the output device is a display. A specific example of the output interface 15 is a High-Definition Multimedia Interface (HDMI, registered trademark) terminal.

A touch panel may be provided with the input interface 14 and the output interface 15.

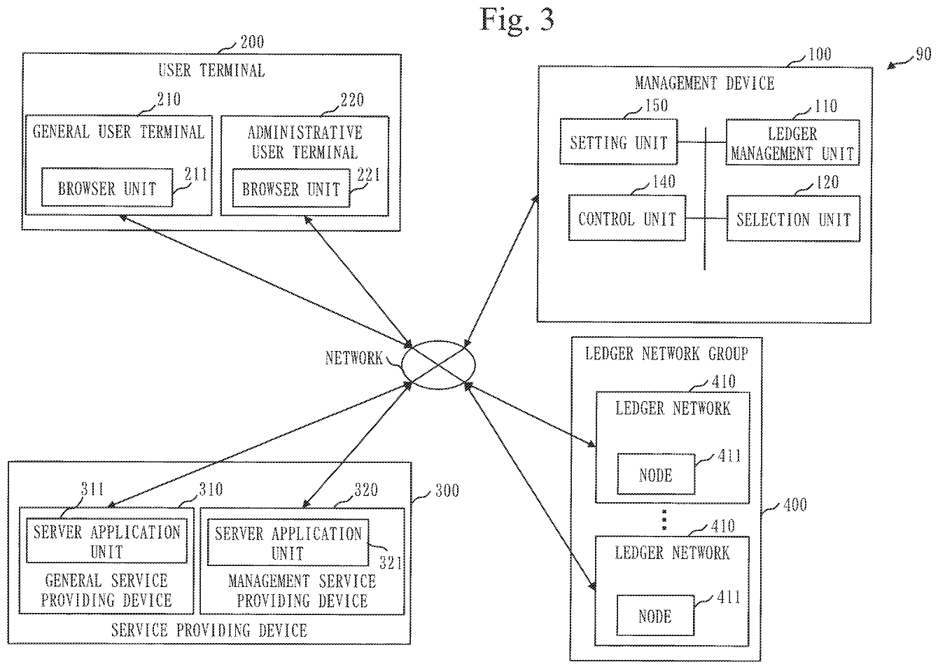

FIG. 3 illustrates a software configuration example of the management system 90. A management device 100 illustrated in this example is typically used for a case where one organization operates one management system 90.

The management device 100 is provided with a ledger management unit 110, a selection unit 120, a control unit 140, and a setting unit 150, as illustrated in FIG. 3.

The ledger management unit 110 reads an operation instruction and operation target data inputted by a user. The operation instruction is an instruction to operate a distributed ledger. A specific example of the operation instruction is an instruction concerning registration of data to the distributed ledger, and update or reference of data registered in the distributed ledger. The operation target data is data corresponding to the operation instruction.

A general user inputs the operation instruction to a general service providing device 310 via the general user terminal 200. The general user may input the operation target data together with the operation instruction.

The ledger management unit 110 manages the ledger status. The ledger management unit 110 selects a distributed ledger candidate with using the operation instruction. The distributed ledger candidate signifies a candidate for the distributed ledger to be controlled by the management device 100. The ledger management unit 110 may use the operation target data when selecting the distributed ledger candidate.

The ledger management unit 110 transfers the distributed ledger candidates to the selection unit 120.

Ledger status information D12 including a ledger status corresponding to an individual one of at least one distributed ledger is recorded in the ledger management unit 110.

Setting information including the ledger status information D12 may be recorded in the ledger management unit 110. The ledger management unit 110 may manage a plurality of distributed ledgers.

The selection unit 120 selects a selective distributed ledger from among the distributed ledger candidates. The selective distributed ledger is a distributed ledger to be dealt with as a target by the management device 100.

When there are a plurality of distributed ledgers that can be the selective distributed ledgers, the selection unit 120 selects one distributed ledger from among the distributed ledger candidates according to a selection rule. The selection rule indicates a regulation of selecting a distributed ledger. Any rule described in the present specification may include a plurality of rules.

The selection rule may be associated with a priority degree. The priority degree indicates a priority order to be followed when the selection unit 120 executes the selection rule.

Selection rule information D21 is recorded in the selection unit 120. The selection rule information D21 includes a selection rule. The selection rule indicates a regulation of uniquely selecting, when there are a plurality of distributed ledger candidates, a distributed ledger from among the plurality of distributed ledger candidates. The selection rule may indicate a regulation of selecting one distributed ledger from among the plurality of distributed ledger candidates. The plurality of distributed ledger candidates are candidates for a distributed ledger to be controlled by the control unit 140. The plurality of distributed ledger candidates consist of two or more distributed ledgers included in a plurality of distributed ledgers provided to the ledger network 410.

When there are a plurality of distributed ledger candidates, the selection unit 120 uniquely selects a distributed ledger from among the plurality of distributed ledger candidates according to the selection rule.

The selection rule information D21 may include a plurality of selection rules and priority degrees which individually correspond to the plurality of selection rules. The selection unit 120 may select a priority rule from among the plurality of selection rules considering priority degrees corresponding to the plurality of selection rules.

Setting information including selection rule information may be recorded in the selection unit 120.

The control unit 140 executes a process that follows a registration request, an update request, or a reference request on a node 411 selected by the selection unit 120. The node 411 executes a process corresponding to the request and transmits result information to the control unit 140. The control unit 140 sends the result information received from the distributed ledger to a service providing device 300. The result information is information indicating an execution result.

The registration request is a request for the distributed ledger, to newly register new data to the distributed ledger. The new data is data that the general user wishes to register newly in the distributed ledger.

The update request is a request for the distributed ledger, to update data registered in the distributed ledger with using update data. The update data is data used for updating the data registered in the distributed ledger.

The reference request is a request for the distributed ledger, to refer to reference data registered in the distributed ledger. The reference data is data used for referring to data registered in the distributed ledger. The reference data may be data corresponding to the reference data. The new data and the update data are like the reference data.

The control unit 140 deletes a distributed ledger whose operation is ended, from among the distributed ledgers managed by the management device 100. Deletion of a distributed ledger by the control unit 140 signifies exclusion of the distributed ledger from the management target by the management device 100. The deleted distributed ledger is typically no longer a distributed ledger being a component of the ledger network 410. The control unit 140 deletes the distributed ledger according to the delete request from an administrative user. The delete request is a request to delete a distributed ledger. The control unit 140 refers to the ledger management unit 110 to identify a distributed ledger whose operation is ended.

The control unit 140 may delete a distributed ledger not in operation. A distributed ledger in operation demonstrates a function of a distributed ledger. The distributed ledger in operation may be a distributed ledger corresponding to a smart contract.

The control unit 140 controls an individual one of at least one distributed ledger in accordance with a ledger status corresponding to an individual one of at least one distributed ledger.

When the ledger status indicates ending operation of a distributed ledger corresponding to the ledger status, the control unit 140 may delete the distributed ledger. The control unit 140 may control one of a plurality of distributed ledgers.

Information including the result information may be called result information. A content of information named result information is not always the same. “Result information” also collectively refers to information indicating a result.

The above remarks about the result information also apply to another information mentioned in the present specification. Any “information” mentioned in the present specification may also collectively refer to information including information indicating a predetermined content.

The setting unit 150 receives setting information and records the received setting information to the ledger management unit 110 or the selection unit 120. The setting information is classified as status setting information or selection rule setting information. The setting information may include information of an auto-update rule. The information of the auto-update rule indicates a regulation of updating the ledger status.

Typically, the “status setting information” collectively refers to information used for setting one of ledger network information D11, the ledger status information D12, status rule information D13, and auto-update rule information D14.

The ledger network information D11 is used when the management device 100 communicates with a distributed ledger. A specific example of the ledger network information D11 is information indicating a configuration of the ledger network 410, information indicating a configuration of the node 411, or information indicating an address of the node 411.

The ledger status information D12 includes a ledger status. A specific example of the ledger status indicates one of permitting new registration of data to a distributed ledger, permitting update of data registered in a distributed ledger, and permitting reference to data registered in a distributed ledger; or a combination of at least two of the permissions mentioned. The ledger status may be information that indicates not accepting new registration of data to a distributed ledger, and permitting update of and reference to data registered in a distributed ledger. The ledger status information D12 may include a ledger status that indicates ending operation of a distributed ledger.

The status rule information D13 indicates a status rule. The status rule indicates a regulation of updating the ledger status of a distributed ledger. A specific example of the status rule information D13 is a rule of updating the ledger status in an order of status T1, status T2, status T3, and status T4. In this example, a status auto-update unit 115 may update the ledger status to status T1 after status T4. Contents of status T1 through status T4 will be described later.

The auto-update rule information D14 indicates the auto-update rule. The auto-update rule indicates a regulation of automatically updating the ledger status by the ledger management unit 110. The auto-update rule may be a regulation indicating an update timing. The update timing is a timing to update the ledger status. The update timing may indicate a day and time, or may indicate an update condition for updating the ledger status. A specific example of the update condition is a state of the distributed ledger. A specific example of the auto-update rule is a regulation of updating the ledger status on a designated day and time, a regulation of updating the ledger status at every designated time period, or a regulation of causing the ledger status to make a transition when a data usage of the distributed ledger exceeds a predetermined value. Another specific example of the auto-update rule information D14 is a rule of checking the status rule information D13 every day at 0:00 and updating the ledger status in accordance with the status rule information D13. The auto-update rule may be formed of a plurality of regulations. The auto-update rule information D14 may include information indicating a distributed ledger whose ledger status is to be updated.

The management system 90 may have a configuration whose ledger status can be changed by the administrative user operating the administrative user terminal 220.

The selection rule information D21 indicates a selection rule. The selection rule is a regulation used by the selection unit 120 when selecting a distributed ledger.

A specific example of the selection rule is a regulation of selecting, when there are a plurality of distributed ledgers in which data can be registered newly, a distributed ledger that was generated at a time point the closest to the present time point among the plurality of distributed ledgers; a regulation of selecting, when there are a plurality of distributed ledgers that can be data-updated, a distributed ledger in which there is data of a source of update among the plurality of distributed ledgers; or a regulation of selecting, when there are a plurality of distributed ledgers in which data can be registered newly, a distributed ledger in which an amount of data recorded is the smallest among the plurality of distributed ledgers. The selection rule may be a regulation of selecting a distributed ledger on the basis of information concerning time, or a regulation of selecting a distributed ledger on the basis of information concerning the data. A specific example of the information concerning the time is a current time point, or a time point at which the distributed ledger is generated. A specific example of the information concerning the data is information included in data related to the distributed ledger. A specific example of the data related to the distributed ledger is data registered in the distributed ledger.

When the setting unit 150 receives the status setting information, the setting unit 150 sets the ledger management unit 110. When the setting unit 150 receives the selection rule setting information, the setting unit 150 sets the selection unit 120.

The administrative user transmits the setting information to the setting unit 150 via a management service providing device 320. The administrative user is a user who has authority to manage a distributed ledger. The general user is a user other than the administrative user. The administrative user may have the same authority as that of the general user. Note that “user” collectively refers to the general user and the administrative user.

The user terminal 200 is classified as a general user terminal 210 or an administrative user terminal 220.

The general user terminal 210 is a terminal that the general user uses. The general user terminal 210 is provided with a browser unit 211.

The general user can newly register data to the distributed ledger or refer to data registered in the distributed ledger by operating the browser unit 211.

The administrative user terminal 220 is a terminal that the administrative user uses. The administrative user terminal 220 is provided with a browser unit 221. The administrative user terminal 220 may have the same function as that of the general user terminal 210.

The administrative user can set the management device 100 or delete a distributed ledger by operating the browser unit 221.

The general user or the administrative user controls the distributed ledger via the management device 100.

The browser unit 211 is an information display application. The information display application has a function of displaying information. A specific example of the information display application is a Web browser or a dedicated application. The browser unit 211 has a function of accepting information from the user and a function of outputting information received from a device. The browser unit 221 is identical to the browser unit 211.

The service providing device 300 is classified as a general service providing device 310 or a management service providing device 320.

The general service providing device 310 mediates communication between the general user terminal 210 and the management device 100. The general service providing device 310 is provided with a server application unit 311.

The server application unit 311 has a communication application. The communication application has a function of mediating communication.

The management service providing device 320 mediates communication between the administrative user terminal 220 and the management device 100. The management service providing device 320 is provided with a server application unit 321.

The server application unit 321 is identical to the server application unit 311.

The node 411 executes processing in accordance with a request from the management device 100.

The ledger network 410 may manage a collection of information by distributing the information among the plurality of nodes 411. The plurality of nodes 411 may manage the same data in an overlapping manner. Transaction data may be recorded in the node 411.

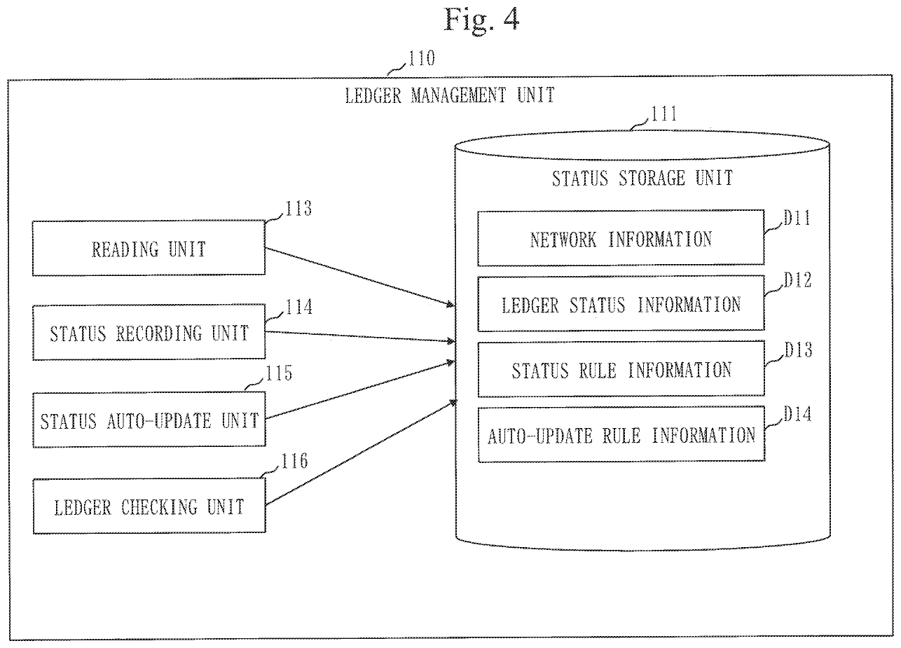

FIG. 4 illustrates a configuration example of the ledger management unit 110. As illustrated in FIG. 4, the ledger management unit 110 is provided with a status storage unit 111, a status reading unit 113, a status recording unit 114, the status auto-update unit 115, and a ledger checking unit 116.

The “ledger management unit 110” also collectively refers to individual units provided to the ledger management unit 110.

The status storage unit 111 can hold the ledger network information D11, the ledger status information D12, the status rule information D13, and the auto-update rule information D14.

The status reading unit 113 reads out information stored in the status storage unit 111. The status reading unit 113 may transfer the readout ledger network information D11 to the selection unit 120.

The status recording unit 114 records information of the ledger status to the status storage unit 111.

The status auto-update unit 115 automatically updates the ledger status on the basis of the auto-update rule information D14 recorded in the status storage unit 111.

The status auto-update unit 115 updates the ledger status in accordance with the auto-update rule.

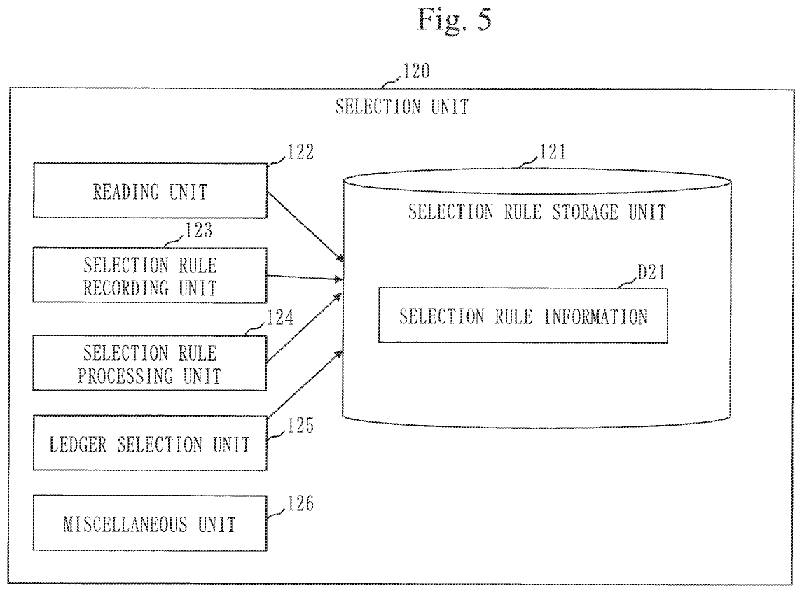

FIG. 5 illustrates a configuration example of the selection unit 120. As illustrated in FIG. 5, the selection unit 120 is provided with a selection rule storage unit 121, a reading unit 122, a selection rule recording unit 123, a selection rule processing unit 124, a ledger selection unit 125, and a miscellaneous unit 126.

The “selection unit 120” also collectively refers to individual units provided to the selection unit 120.

The selection rule storage unit 121 holds selection rule information D21 and other information.

The reading unit 122 reads out information recorded in the selection rule storage unit 121.

The selection rule recording unit 123 records the selection rule information D21 to the selection rule storage unit 121.

The selection rule processing unit 124 selects one distributed ledger in accordance with the selection rule information D21. The selection rule processing unit 124 may use the ledger network information D11.

The selection rule processing unit 124 may send information indicating the selected distributed ledger to the control unit 140.

The ledger selection unit 125 selects a distributed ledger.

The miscellaneous unit 126 executes a process necessary for implementing a function of the selection unit 120.

The status storage unit 111 may be any memory area as far as it is provided with an input/output means. The status storage unit 111 need not be integrally formed with another unit of the management device 100. A specific example of the status storage unit 111 is a file system or a database.

The selection rule storage unit 121 is identical to the status storage unit 111.

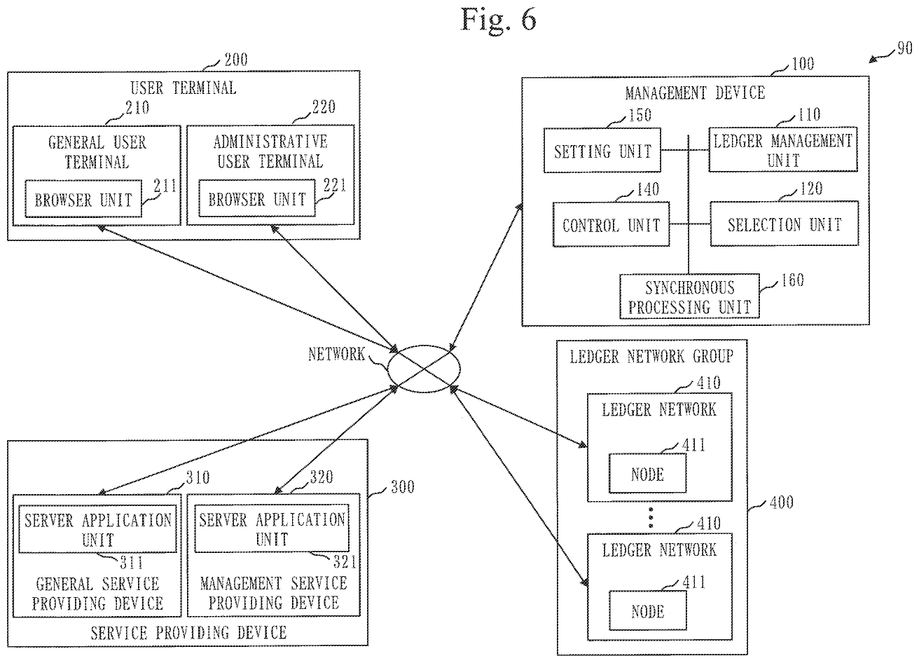

FIG. 6 illustrates a software configuration example of the management system 90. Typically, the management device 100 illustrated in this example is used when a plurality of organizations operate one management system 90. The management system 90 is provided with a management device 100 and another management device 100 having the same function as that of the management device 100.

A difference between FIGS. 3 and 6 resides in whether there is a synchronous processing unit 160 or not.

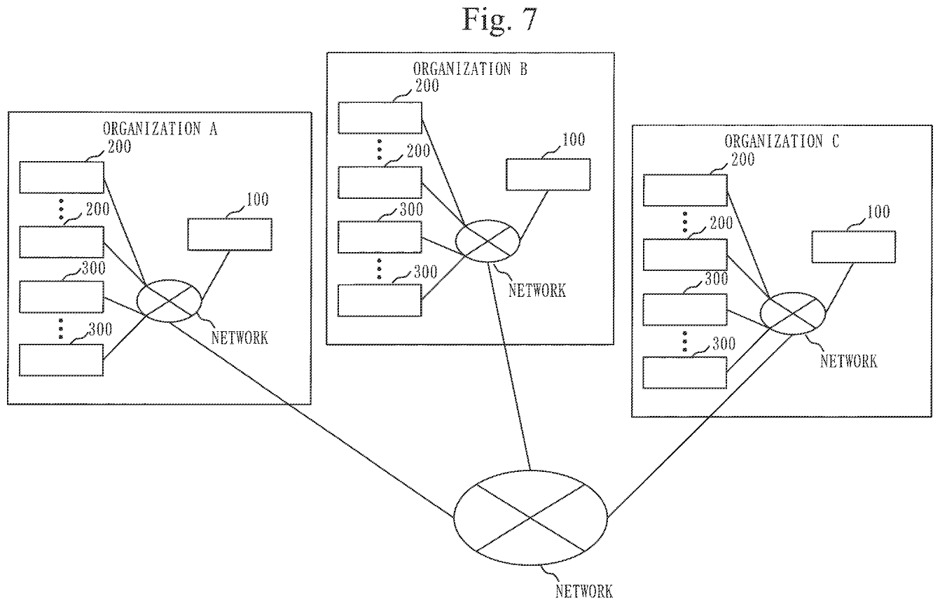

FIG. 7 illustrates a configuration example of the management system 90 in a case where a management system 90 is shared by a plurality of organizations. In this example, three organizations which are an organization A, an organization B, and an organization C share the management system 90.

The individual organizations are connected to each other via a network. Specifically, a management device 100 of the organization A is connected to a management device 100 of the organization B and a management device 100 of the organization C via the network.

Each organization has one management device 100. Each organization has one or more user terminals 200 and one or more service providing devices 300. The organization may be a divisional unit of one organization, such as a department. One organization may be regarded as a plurality of organizations.

When a plurality of organizations share one management system 90, the plurality of organizations operate a plurality of distributed ledgers simultaneously. The distributed ledger is used when sharing data among a plurality of organizations. In this case, typically, the plurality of organizations individually operate different management devices 100.

The synchronous processing unit 160 shares setting information with another management device 100. The synchronous processing unit 160 synchronizes the setting information with another management device 100.

In a specific example where the three organizations which are the organization A, the organization B, and the organization C share the management system 90, assume that setting information of the management device 100 possessed by the organization A is changed.

In this example, first, the synchronous processing unit 160 of the organization A transmits the setting information to the individual synchronous processing units 160 of the organization B and organization B via the network. Subsequently, the synchronous processing unit 160 of each of the organization B and the organization C transmits the setting information to the ledger management unit 110 or selection unit 120 of each organization.

With the above processing, the user can set the management device 100 of each of the organization B and the organization C only by setting the management device 100 of the organization A.

Description of Operations

An operation procedure of the management device 100 corresponds to a management method. A program that implements operations of the management device 100 corresponds to the management program.

An operation procedure of the user terminal 200 corresponds to a user terminal method. A program that implements operations of the user terminal 200 corresponds to a user terminal program.

An operation procedure of the service providing device 300 corresponds to a service providing method. A program that implements operations of the service providing device 300 corresponds to the service providing program.

In the following example, assume that each distributed ledger to be operated takes four ledger statuses which are status T1, status T2, status T3, and status T4 unless otherwise noted, but the number of status types and status contents are not limited to them.

Status T1 signifies permitting registration, update, and reference. In status T1, the user can register data to the distributed ledger, and update or refer to data registered in the distributed ledger.

Status T2 signifies permitting update and reference. In status T2, the user cannot register data to the distributed ledger. In status T2, the user can update or refer to data registered in the distributed ledger.

Status T3 signifies permitting reference. In status T3, the user can only refer to data registered in the distributed ledger.

Status T4 signifies ending operation of the distributed ledger. In status T4, the general user cannot register data to the distributed ledger, nor update or refer to data registered in the distributed ledger. In status T4, the administrative user can only execute delete of the distributed ledger.

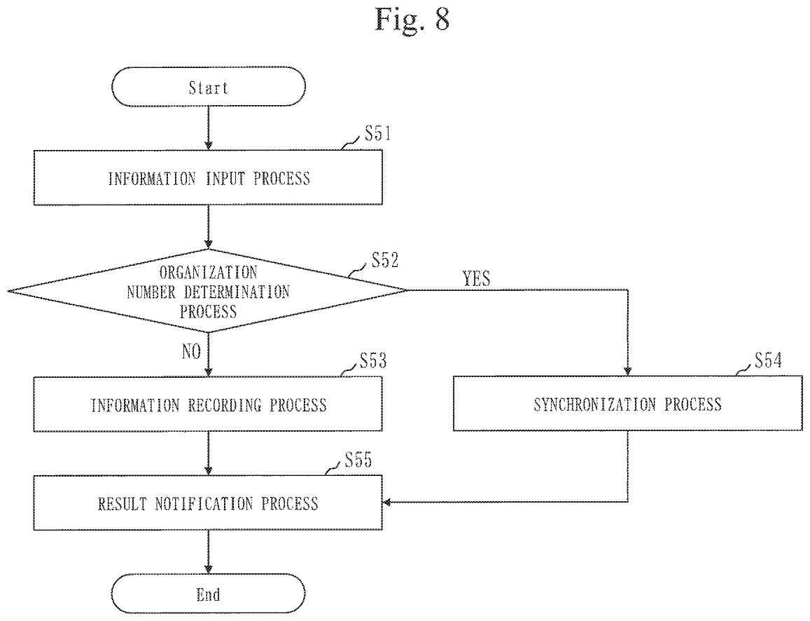

FIG. 8 is a flowchart illustrating an example of a status setting process. The status setting process will be described with referring to FIG. 8. The status setting process is a process of recording information to the status storage unit 111.

(Step S51: Information Input Process)

First, the administration user operates the browser unit 221 to input the status setting information. The status setting information corresponds to at least one of the ledger network information D11, the ledger status information D12, the status rule information D13, and the auto-update rule information D14.

Subsequently, the administrative user terminal 220 sends the status setting information to the server application unit 321.

Subsequently, the management service providing device 320 sends the status setting information to the setting unit 150.

(Step S52: Organization Number Determination Process)

The setting unit 150 determines whether the management system 90 is being operated by a plurality of organizations or not.

If the management system 90 is being operated by the plurality of organizations, the management device 100 proceeds to step S54. Otherwise, the management device 100 proceeds to step S53.

(Step S53: Information Recording Process)

First, the setting unit 150 sends the status setting information to the ledger management unit 110.

Subsequently, the status recording unit 114 records the relevant status information to the status storage unit 111.

(Step S54: Synchronization Process)

The synchronous processing unit 160 shares the status setting information with another management device 100 in the management system 90. This another management device 100 is a management device 100 which is within the management system 90 and which is other than the management device 100 that has received the status setting information in step S51.

In this step, in a specific example, first, the setting unit 150 transmits the status setting information to the synchronous processing unit 160.

Subsequently, the synchronous processing unit 160 sends the status setting information to the synchronous processing units 160 provided to all the other management devices 100.

Subsequently, the synchronous processing units 160 provided to the other management devices 100 individually transmit the received status setting information to the corresponding setting units 150.

Subsequently, the other management devices 100 individually execute the same process as that of step S53.

Subsequently, the setting units 150 provided to the other management devices 100 individually transmit information indicating an execution result to the management device 100 that has transmitted the status setting information.

(Step S55: Result Notification Process)

The management system 90 notifies the administrative user of the execution result of the status setting process.

In this step, in a specific example, first, the setting unit 150 sends the result information to the server application unit 321.

Subsequently, the management service providing device 320 sends the result information to the browser unit 221.

Subsequently, the browser unit 221 displays an image corresponding to the result information.

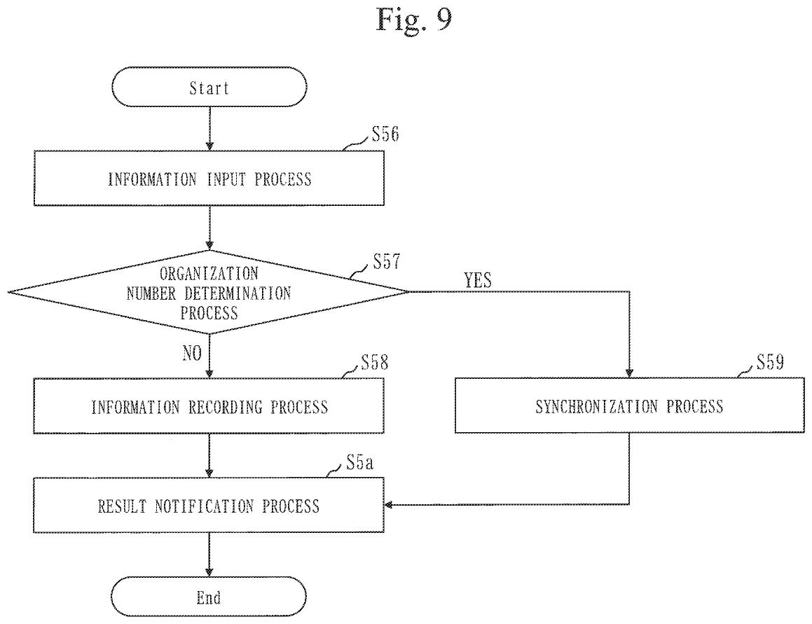

FIG. 9 is a flowchart illustrating an example of a selection rule setting process. The selection rule setting process will be described with referring to FIG. 9. The selection rule setting process is a process of recording information to the selection rule storage unit 121.

(Step S56: Information Input Process)

This process is identical to step S51 but the status setting information is changed to the selection rule setting information. The selection rule setting information corresponds to the selection rule information D21.

(Step S57: Organization Number Determination Process)

The setting unit 150 executes the same process as that of step S52.

If the management system 90 is being operated by the plurality of organizations, the management device 100 proceeds to step S59. Otherwise, the management device 100 proceeds to step S58.

(Step S58: Information Recording Process)

First, the setting unit 150 sends the selection rule setting information to the selection unit 120.

Subsequently, the selection rule recording unit 123 records the relevant selection rule setting information to the selection rule storage unit 121.

(Step S59: Synchronization Process)

The setting unit 150 utilizes the synchronous processing units 160 to share the selection rule setting information with another management device 100 in the organization.

The management device 100 executes a process identical to the process of step S54 but the status setting information is changed to the selection rule setting information, step S51 is changed to step S56, and step S53 is changed to step S58.

(Step S5a: Result Notification Process)

The management system 90 notifies the administrative user of an execution result of the selection rule setting process.

This process is identical to the process of step S55.

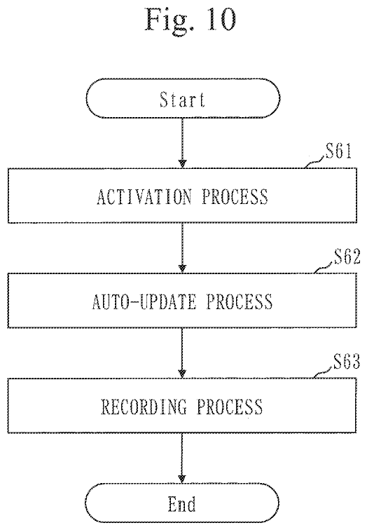

FIG. 10 is a flowchart illustrating an example of a status auto-update process. The status auto-update process will be described with referring to FIG. 10. The status auto-update process is a process in which the status auto-update unit 115 automatically updates the ledger status.

(Step S61: Activation Process)

The status auto-update unit 115 is activated according to the update timing indicated in the auto-update rule information D14.

(Step S62: Auto-Update Process)

The status auto-update unit 115 updates the ledger status of each update distributed ledger. The update distributed ledger is a distributed ledger which is to be instructed by the status auto-update unit 115 to update its ledger status. There may be a plurality of update distributed ledgers. The status auto-update unit 115 may treat each of all distributed ledgers in operation as the update distributed ledger, or may treat a distributed ledger indicated by the auto-update rule information D14 as the update distributed ledger.

In this step, in a specific example, first, the status reading unit 113 reads the ledger network information D11 and the status rule information D13 from the status storage unit 111. The relevant ledger network information D11 corresponds to the update distributed ledger. The relevant status rule information D13 may be the one indicated by the auto-update rule information D14.

Subsequently, the status reading unit 113 sends the ledger network information D11 and the status rule information D13 to the status auto-update unit 115.

Subsequently, the status auto-update unit 115 generates status update request information on the basis of the status rule information D13. The status update request information indicates a request for a distributed ledger to update a status.

Subsequently, the status auto-update unit 115 transmits the update request information to the update distributed ledger with using the ledger network information D11.

Subsequently, the update distributed ledger updates its ledger status in accordance with the status update request information.

Subsequently, the update distributed ledger sends result information to the status auto-update unit 115.

(Step S63: Recording Process)

Subsequently, on the basis of the result information, the status auto-update unit 115 updates the ledger status information D12 recorded in the status storage unit 111.

If the administrative user updates the auto-update rule information D14 recorded in the status storage unit 111, the status auto-update unit 115 checks the new auto-update rule information D14. In a specific example, the status auto-update unit 115 checks an update timing.

In the following example, data registered in the distributed ledger or data to be registered in the distributed ledger is formed of a data identification (ID) and a data object unless otherwise noted. The data ID is an identifier to identify data. The data object is a content of the data and is information other than the data ID.

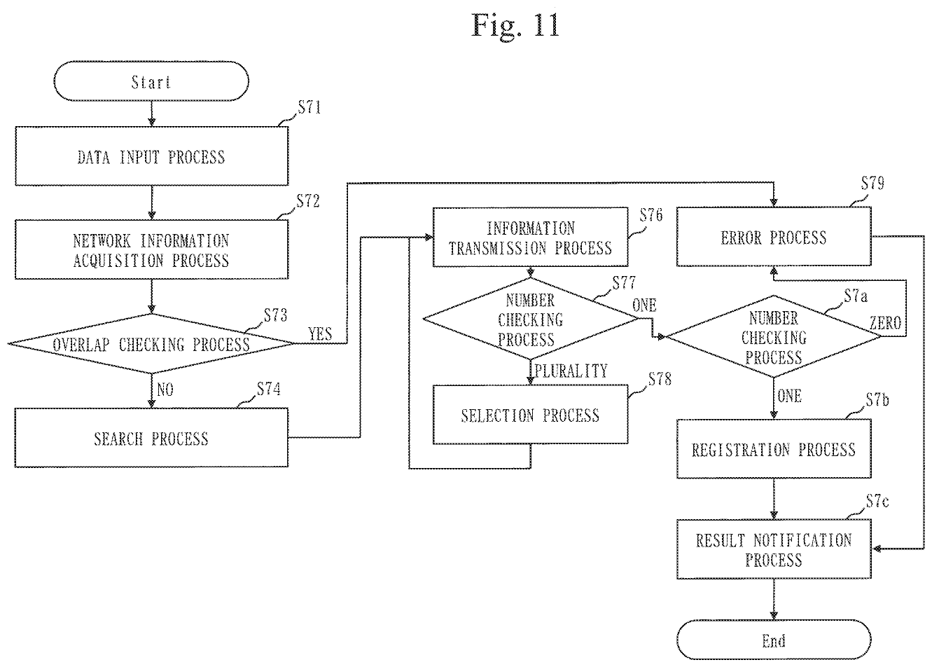

FIG. 11 is a flowchart illustrating an example of a new data registration process. The new data registration process will be described with referring to FIG. 11. A data registration process is a process of newly registering data to a distributed ledger.

(Step S71: Data Input Process)

The ledger management unit 110 accepts registration request information from a general user. The registration request information indicates a registration request from the general user and includes new data.

In this step, in a specific example, first, the general user inputs the new data to the browser unit 211.

Subsequently, the general user terminal 210 sends the registration request information to the server application unit 311.

Subsequently, the general service providing device 310 sends the registration request information to the ledger management unit 110.

(Step S72: Network Information Acquisition Process)

The status reading unit 113 acquires ledger network information D11 individually corresponding to all the distributed ledgers in operation from the status storage unit 111.

Specifically, the status reading unit 113 acquires the ledger network information D11 individually corresponding to all the distributed ledgers whose ledger statuses are status T1, status T2, or status T3.

The ledger network information D11 acquired in this step will be treated as acquired network information.

(Step S73: Overlap Checking Process)

The ledger checking unit 116 checks whether there is an overlapping distributed ledger or not. The overlapping distributed ledger is a distributed ledger in which data including the same data ID as the data ID included in the new data is recorded.

In a specific example, the ledger checking unit 116 searches for an overlapping distributed ledger with using the new data and the acquired network information.

If there is no overlapping distributed ledger, the management device 100 proceeds to step S74. Otherwise, the management device 100 proceeds to step S79.

An objective of this step is to prevent the ledger network 410 from managing by distribution a plurality of pieces of data having the same data ID. By executing the process of this step, the management device 100 can prevent pieces of data having the same data ID from being recorded in one distributed ledger or among a plurality of distributed ledgers by distribution.

(Step S74: Search Process)

The ledger management unit 110 searches for a distributed ledger corresponding to a ledger status that indicates permitting registration. When the ledger management unit 110 according to the present disclosure searches for a distributed ledger, the ledger management unit 110 may search for a plurality of distributed ledgers.

Specifically, the status reading unit 113 refers to the status storage unit 111 to search for a distributed ledger whose ledger status is status T1.

If the ledger management unit 110 finds one or more relevant distributed ledgers, the management device 100 proceeds to step S76. Otherwise, the management device 100 proceeds to step S79.

The distributed ledger found in this step will be treated as a distributed ledger candidate.

(Step S76: Information Transmission Process)

The status reading unit 113 acquires the ledger network information D11 corresponding to the distributed ledger candidate from the status storage unit 111, and sends the acquired ledger network information D11 to the selection unit 120.

When there are a plurality of distributed ledger candidates and when the status reading unit 113 according to the present disclosure is to acquire the ledger network information D11, the reading unit 113 may acquire ledger network information D11 corresponding to individual one of the relevant plurality of pieces of distributed ledgers.

(Step S77: Number Checking Process)

The miscellaneous unit 126 checks the number of distributed ledger candidates.

If there are a plurality of distributed ledger candidates, the management device 100 proceeds to step S78. Otherwise, the management device 100 treats the distributed ledger candidate as a selective distributed ledger, and proceeds to step S7a.

(Step S78: Selection Process)

The selection unit 120 selects one distributed ledger from among the plurality of distributed ledger candidates.

In this step, in a specific example, first, the reading unit 122 refers to the selection rule storage unit 121 to extract a priority rule. The priority rule is a selection rule having a highest priority degree. If there are a plurality of selection rules having the highest priority degree, the reading unit 122 may select the priority rule in any manner.

Subsequently, the selection rule processing unit 124 selects one distributed ledger from among the plurality of distributed ledger candidates according to the priority rule. The selection rule processing unit 124 treats the selected distributed ledger candidate as a selective distributed ledger.

(Step S79: Error Process)

The miscellaneous unit 126 executes an error process. The miscellaneous unit 126 may select a process as necessary according to a cause of the error.

The miscellaneous unit 126 sends to the control unit 140 result information indicating an error occurrence.

(Step S7a: Number Checking Process)

The miscellaneous unit 126 checks the number of selective distributed ledgers.

If the number of selective distributed ledgers is one, the management device 100 proceeds to step S7b. Otherwise, the management device 100 proceeds to step S79.

(Step S7b: Registration Process)

The control unit 140 causes the selective distributed ledger to newly register new data.

In this step, in a specific example, first, the selection unit 120 sends the new data and information indicating the selective distributed ledger to the control unit 140.

Subsequently, the control unit 140 instructs the selective distributed ledger to newly register the new data.

Subsequently, the selective distributed ledger registers the new data newly and then sends result information to the control unit 140.

(Step S7c: Result Notification Process)

The management device 100 notifies the general user of an execution result.

In this step, in a specific example, first, the control unit 140 transmits the result information to the server application unit 311.

Subsequently, the general service providing device 310 transmits the result information to the browser unit 211.

Subsequently, the browser unit 211 displays an image corresponding to the result information.

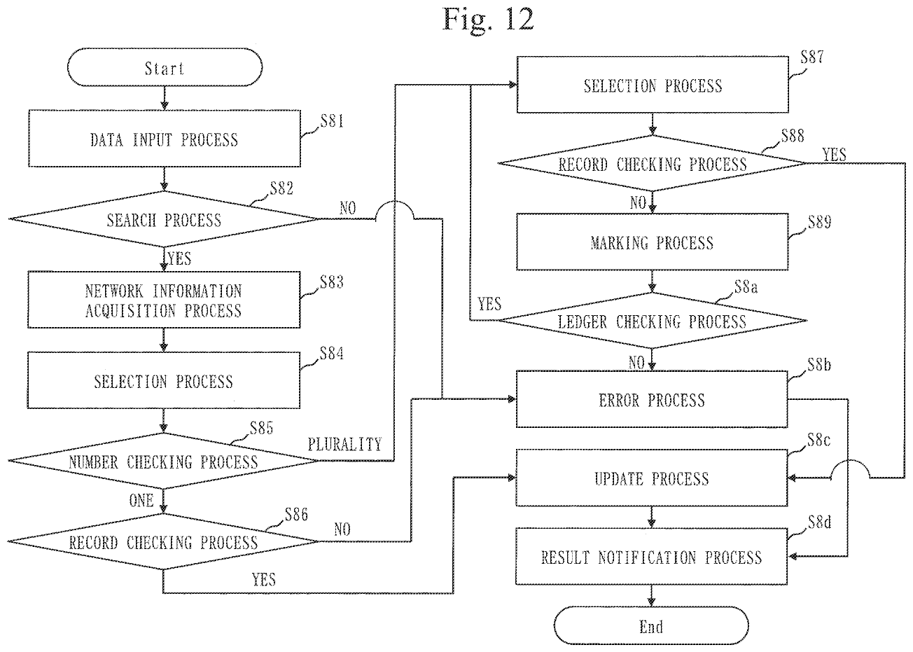

FIG. 12 illustrates a flowchart of the update data registration process. The update data registration process will be described with referring to FIG. 12. The update data is used for updating data registered in the distributed ledger. When the management system 90 has successfully executed the update data registration process, data registered in the distributed ledger before the management system 90 executes this process is updated with data corresponding to the update data.

When the management device 100 updates the data registered in the distributed ledger, the management device 100 updates update target data. The update target data has been registered in the distributed ledger and has the same data ID as data ID included in the update data.

(Step S81: Data Input Process)

This process is identical to the process of step S71 but the registration request information is changed to update request information and the new data is changed to update data. The update request information indicates an update request from the general user and includes the update data.

(Step S82: Search Process)

The ledger management unit 110 searches for a distributed ledger corresponding to a ledger status that indicates permitting update.

Specifically, the status reading unit 113 refers to the status storage unit 111 to search for a distributed ledger whose ledger status is status T1 or status T2.

If the ledger management unit 110 finds one or more relevant distributed ledgers, the management device 100 proceeds to step S83. Otherwise, the management device 100 proceeds to step S8b.

(Step S83: Network Information Acquisition Process)

The status reading unit 113 acquires the ledger network information D11 corresponding to the distributed ledger found in step S82 from the status storage unit 111, and sends the acquired ledger network information D11 to the selection unit 120. When a plurality of distributed ledgers are found in step S82, the ledger management unit 110 acquires ledger network information D11 corresponding to individual one of the relevant plurality of distributed ledgers.

The ledger network information D11 acquired in this step will be treated as acquired network information.

(Step S84: Selection Process)

The ledger selection unit 125 selects an update distributed ledger. The update distributed ledger is checked by the ledger selection unit 125 as to whether update target data is recorded in it. The selection unit 120 may treat the distributed ledger found in step S82 as the update distributed ledger. The selection unit 120 may select a plurality of update distributed ledgers. When the selection unit 120 according to the present disclosure is to select a distributed ledger, the selection unit 120 may select a plurality of distributed ledgers.

(Step S85: Number Checking Process)

The miscellaneous unit 126 checks the number of update distributed ledgers.

If there are a plurality of update distributed ledgers, the management device 100 proceeds to step S87. Otherwise, the ledger selection unit 125 treats the update distributed ledger as a selective distributed ledger, and the management device 100 proceeds to step S86.

(Step S86: Record Checking Process)

The selection unit 120 checks whether update target data is recorded in the selective distributed ledger or not. In a specific example, the selection unit 120 checks the selective distributed ledger with using the acquisition network information and the data ID which is included in the update data.

If update target data is recorded in the selective distributed ledger, the management device 100 proceeds to step S8c. Otherwise, the management device 100 proceeds to step S8b.

In place of the selection unit 120, the control unit 140 may check the data recorded in the selective distributed ledger.

(Step S87: Selection Process)

The ledger selection unit 125 selects one update distributed ledger that has not been selected yet in this step, and treats the selected update distributed ledger as a selective distributed ledger.

The update distributed ledger to be selected by the ledger selection unit 125 has not been marked in step S89.

(Step S88: Record Checking Process)

The ledger selection unit 125 executes a process identical to that of step S86. If update target data is recorded in the selective distributed ledger, the management device 100 proceeds to step S8c. Otherwise, the management device 100 proceeds to step S89.

(Step S89: Marking Process)

The ledger selection unit 125 attaches a mark to the selective distributed ledger to indicate that it has already been selected.

(Step S8a: Ledger Checking Process)

The ledger selection unit 125 checks whether there is an update distributed ledger that has not been selected yet in step S87.

If there is an update distributed ledger that has not been selected yet in step S87, the management device 100 proceeds to step S87. Otherwise, the management device 100 proceeds to step S8b.

(Step S8b: Error Process)

The miscellaneous unit 126 executes an error process. The miscellaneous unit 126 transmits to the control unit 140 result information indicating an error.

(Step S8c: Update Process)

The control unit 140 records update data to the selective distributed ledger.

In this step, in a specific example, first, the ledger selection unit 125 sends the update data and information which indicates the selective distributed ledger to the control unit 140.

Subsequently, the control unit 140 instructs the selective distributed ledger to update the update target data with the update data.

Subsequently, the selective distributed ledger updates the update target data with the update data and transmits result information to the control unit 140.

(Step S8d: Result Notification Process)

This process is identical to the process of step S7c.

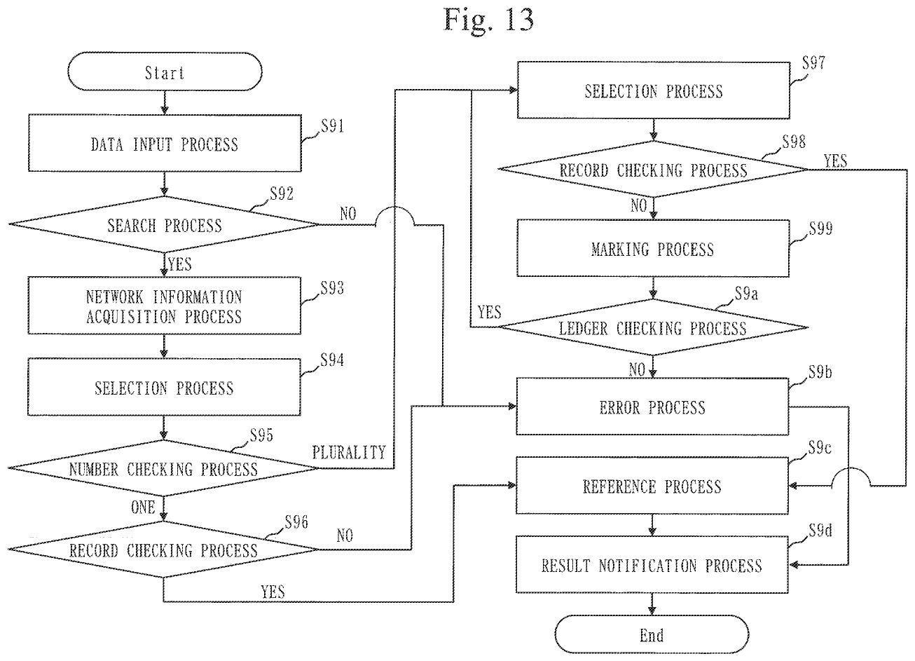

FIG. 13 is a flowchart illustrating an example of a data reference process. The data reference process will be described with referring to FIG. 13. The data reference process is a process of referring to reference target data registered in the distributed ledger by the user. The reference target data corresponds to the reference data. The reference data may include only a data ID or only a data object. The reference data may be information indicating an attribute of data or a type of data. The reference target data is identical to the reference data.

(Step S91: Data Input Process)

This process is identical to the process of step S71 but the registration request information is changed to reference request information and the new data is changed to reference data. The reference request information indicates a reference request from the general user and includes the reference data.

(Step S92: Search Process)

The ledger management unit 110 searches for a distributed ledger corresponding to a ledger status that indicates permitting update.

Specifically, the status reading unit 113 refers to the status storage unit 111 to search for a distributed ledger whose ledger status is status T1, status T2, or status T3.

If the ledger management unit 110 finds one or more relevant distributed ledgers, the management device 100 proceeds to step S93. Otherwise, the management device 100 proceeds to step S9b.

(Step S93: Network Information Acquisition Process)

This process is identical to the process of step S83 but step S82 is changed to step S92.

(Step S94: Selection Process)

The ledger selection unit 125 selects a reference distributed ledger. The reference distributed ledger is checked by the ledger selection unit 125 as to whether reference data is recorded in it or not. The selection unit 120 may treat the distributed ledger found in step S92 as the reference distributed ledger.

(Step S95: Number Checking Process)

The miscellaneous unit 126 checks the number of reference distributed ledgers.

If there are a plurality of reference distributed ledgers, the management device 100 proceeds to step S97. Otherwise, the ledger selection unit 125 treats the reference distributed ledger as a selective distributed ledger, and the management device 100 proceeds to step S96.

(Step S96: Record Checking Process)

The selection unit 120 checks whether reference target data is recorded in the selective distributed ledger or not. The selection unit 120 executes the same process as that of step S86.

If reference data is recorded in the selective distributed ledger, the management device 100 proceeds to step S9c. Otherwise, the management device 100 proceeds to step S9b.

(Step S97: Selection Process)

The ledger selection unit 125 selects one reference distributed ledger that has not been selected yet in this step, and treats the selected reference distributed ledger as a selective distributed ledger. This process is identical to the process of step S87.

(Step S98: Record Checking Process)

The ledger selection unit 125 executes a process identical to that of step S96.

If reference target data is recorded in the selective distributed ledger, the management device 100 proceeds to step S9c. Otherwise, the management device 100 proceeds to step S99.

(Step S99: Marking Process)

This process is identical to the process of step S89.

(Step S9a: Ledger Checking Process)

This process is identical to the process of step S8a.

If there is a reference distributed ledger that has not been selected yet in step S97, the management device 100 proceeds to step S97. Otherwise, the management device 100 proceeds to step S9b.

(step S9b: Error Process)

This process is identical to the process of step S8b.

(Step S9c: Reference Process)

The control unit 140 refers to the reference target data recorded in the selective distributed ledger.

In this step, in a specific example, first, the ledger selection unit 125 sends the reference data and information which indicates the selective distributed ledger to the control unit 140.

Subsequently, the control unit 140 instructs the selective distributed ledger to return information of the reference target data.

Subsequently, the selective distributed ledger transmits the reference target data and result information to the control unit 140.

(Step S9d: Result Notification Process)

This process is identical to the process of step S7c.

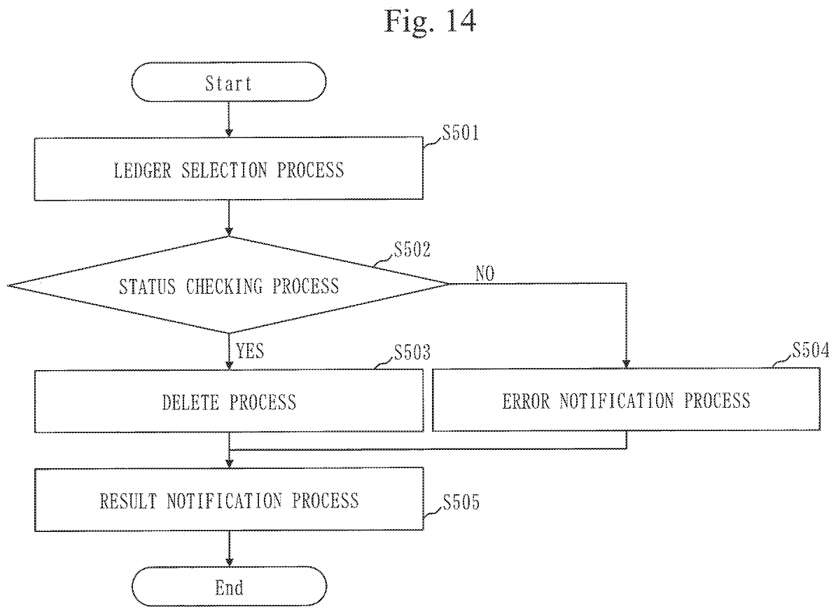

FIG. 14 is a flowchart illustrating an example of a ledger delete process conducted by the management device 100. The ledger delete process will be described with referring to FIG. 14. The ledger delete process is a process of deleting a distributed ledger.

(Step S501: Ledger Selection Process)

The administrative user selects a deletion distributed ledger. The deletion distributed ledger is a distributed ledger that the administrative user wishes to delete.

In this step, in a specific example, the administrative user selects a deletion distributed ledger by utilizing the browser unit 221 of the administrative user terminal 220.

Subsequently, the administrative user terminal 220 sends delete request information to the server application unit 321. The delete request information indicates a request for the administrative user to delete a deletion distributed ledger and includes information of the deletion distributed ledger.

Subsequently, the management service providing device 320 sends the delete request information to the control unit 140.

(Step S502: Status Checking Process)

The control unit 140 checks whether a ledger status corresponding to the deletion distributed ledger indicates an operation end or not.

In this step, in a specific example, first, the control unit 140 inquires a ledger status corresponding to the deletion distributed ledger from the ledger management unit 110.

Subsequently, the ledger management unit 110 refers to the status storage unit 111 to acquire ledger status information D12 corresponding to the deletion distributed ledger, and sends the acquired ledger status information D12 to the control unit 140.

Subsequently, the control unit 140 checks whether the ledger status of the deletion distributed ledger is status T4 or not.

If the ledger status of the deletion distributed ledger is status T4, the management device 100 proceeds to step S503. Otherwise, the management device 100 proceeds to step S504.

(Step S503: Delete Process)

The control unit 140 deletes the deletion distributed ledger.

In this step, in a specific example, first, the control unit 140 inquires ledger network information D11 corresponding to the deletion distributed ledger from the ledger management unit 110.

Subsequently, the ledger management unit 110 refers to the status storage unit 111 to acquire the ledger network information D11 corresponding to the deletion distributed ledger, and sends the acquired ledger network information D11 to the control unit 140.

Subsequently, the control unit 140 transmits delete request information to the deletion distributed ledger with using the ledger network information D11.

Subsequently, the control unit 140 sends to the server application unit 321 result information indicating that the process is ended normally.

(Step S504: Error Notification Process)

The control unit 140 sends to the server application unit 321 result information indicating that an error has occurred.

(Step S505: Result Notification Process)

The management system 90 notifies the administrative user of an execution result of the ledger delete process.

The management service providing device 320 transmits result information received from the management device 100 to the browser unit 221.

The browser unit 221 displays an image corresponding to the result information received from the management service providing device 320.

Description of Effect of Embodiment 1

As has been described above, according to the present embodiment, the management device 100 gives a ledger status to each of one or more distributed ledgers. The ledger status corresponds to the state of the distributed ledger. The management device 100 restricts processes that the user can execute, in accordance with the ledger status.

The management device 100 deletes a distributed ledger as necessary in accordance with the ledger status. Therefore, according to the present embodiment, the management device 100 can prevent excessive increase of a storage usage of the distributed ledger that accompanies long-term operation.

The management device 100 can also operate the distributed ledger while taking a life cycle of the distributed ledger into consideration. The ledger status may indicate the life cycle of the distributed ledger. The management device 100 may delete, as necessary, a distributed ledger in which life cycles of all registered data have expired.

According to the present embodiment, when there are a plurality of candidates for a distributed ledger to be controlled by the management device 100, the selection unit 120 can uniquely select a distributed ledger according to the selection rule. Also, the administrative user can set the selection rule.

Therefore, according to the present embodiment, the user can, for example, record data to a distributed ledger included in the ledger network 410, and refer to data recorded in the distributed ledger included in the ledger network 410, without paying attention to the plurality of distributed ledgers in the ledger network 410.

### Other Configurations

<Modification 1>

The selection unit 120 need not select one distributed ledger from among a plurality of distributed ledgers. In the present modification, in a specific example, the selection unit 120 provides the user with an opportunity to select a distributed ledger. In this example, the selection unit 120 may treat the distributed ledger selected by the user, as a selective distributed ledger.

<Modification 2>

The status storage unit 111 may possess a data ID corresponding to data recorded in the distributed ledger.

In this modification, in a specific example, the ledger checking unit 116 decides whether there is an overlapping distributed ledger or not in step S73 without checking the distributed ledger and by referring to the status storage unit 111.

<Modification 3>

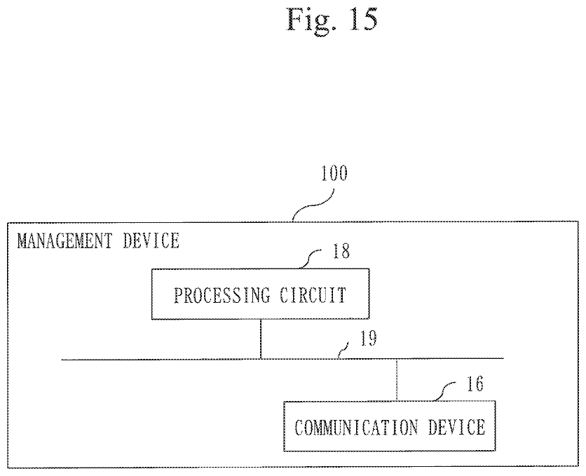

FIG. 15 illustrates a hardware configuration example of a management device 100 according to the present modification.

The management device 100 is provided with a processing circuit 18 in place of at least one of the processor 11, the memory 12, and the auxiliary storage device 13, as illustrated in FIG. 15.

The processing circuit 18 is hardware that implements at least some of individual units provided to the management device 100.

The processing circuit 18 may be dedicated hardware or may be a processor 11 which runs a program stored in the memory 12.

If the processing circuit 18 is dedicated hardware, the processing circuit 18 is, in a specific example, a single circuit, a composite circuit, a programmed processor, a parallel-programmed processor, an Application Specific Integrated Circuit (ASIC), or a Field-Programmable Gate Array (FPGA); or a combination of a single circuit, a composite circuit, a programmed processor, a parallel-programmed processor, an ASIC, and an FPGA.

The management device 100 may be provided with a plurality of processing circuits that substitute for the processing circuit 18. The plurality of processing circuits share roles of the processing circuit 18.

In the management device 100, some of the functions may be implemented by dedicated hardware, and the remaining functions may be implemented by software or firmware.

In a specific example, the processing circuit 18 is implemented by hardware, software, or firmware; or a combination of hardware, software, and firmware.

The processor 11, the memory 12, the auxiliary storage device 13, and the processing circuit 18 are collectively referred to as “processing circuitry”. That is, the functions of the individual function components of the management device 100 are implemented by processing circuitry.

Although not illustrated, each of the user terminal 200, the service providing device 300, and the node 411 may be provided with a processing circuit 18, just as the management device 100 is.

### Other Embodiments

Embodiment 1 has been described. A plurality of portions of the present embodiment may be practiced in combination. Alternatively, one portion of the present embodiment may be practiced. The present embodiment may be subjected to a variety of modifications as necessary, and may be practiced in any combination partially or entirely.

The embodiment described above is an essentially preferable exemplification and is not intended to limit the present disclosure, an applied product of the present disclosure, and a scope of use of the present disclosure. The procedures described with using flowcharts and so on may be changed as necessary.

### REFERENCE SIGNS LIST

11: processor; 12: memory; 13: auxiliary storage device; 14: input interface; 15: output interface; 16: communication device; 18: processing circuit; 19: signal line; 90: management system; 100: management device; 110: ledger management unit; 111: status storage unit; 113: reading unit; 114: status recording unit; 115: status auto-update unit; 116: ledger checking unit; 120: selection unit; 121: selection rule storage unit; 122: reading unit; 123: selection rule recording unit; 124: selection rule processing unit; 125: ledger selection unit; 126: miscellaneous unit; 140: control unit; 150: setting unit; 160: synchronous processing unit; 200: user terminal; 210: general user terminal; 211: browser unit; 220: administrative user terminal; 221: browser unit; 300: service providing device; 310: general service providing device; 311: server application unit; 320: management service providing device; 321: server application unit; 400: ledger network group; 410: ledger network; 411: node; D11: ledger network information; D12: ledger status information; D13: status rule information; D14: auto-update rule information; D21: selection rule information; T1: status; T2: status; T3: status; T4: status.

1. A management device comprising
processing circuitry
in which ledger status information including a ledger status is recorded, the ledger status indicating control restriction corresponding to an individual one of at least one distributed ledger which records distributed electronic data and to which control restriction is applied, to accept an operation instruction being an instruction to operate one of said at least one distributed ledger, and to search for a distributed ledger corresponding to a ledger status that indicates permitting a process corresponding to the operation instruction, from said at least one distributed ledger, and
to control an individual one of said at least one distributed ledger in accordance with the ledger status corresponding to an individual one of said at least one distributed ledger.

2. The management device according to claim 1,
wherein the ledger status information includes a ledger status indicating:
permitting new registration of data to a distributed ledger,
permitting update of data registered in a distributed ledger, and
permitting reference to data registered in a distributed ledger; or
a combination of at least two out of permitting new registration of data to a distributed ledger, permitting update of data registered in a distributed ledger, and permitting reference to data registered in a distributed ledger,
wherein setting information including information of an auto-update rule that indicates a regulation of updating the ledger status is stored in the processing circuitry, and
wherein the processing circuitry updates the ledger status in accordance with the auto-update rule.

3. The management device according to claim 2,
wherein the setting information includes the ledger status information.

4. The management device according to claim 2,
wherein a management system comprising another management device comprises the management device, said another management device having a function that is the same as a function of the management device, and
wherein the processing circuitry synchronizes the setting information with said another management device.

5. The management device according to claim 3,
wherein a management system comprising another management device comprises the management device, said another management device having a function that is the same as a function of the management device, and
wherein the processing circuitry synchronizes the setting information with said another management device.

6. The management device according to claim 1,
wherein the ledger status information includes a ledger status that indicates ending operation of a distributed ledger, and
wherein when the ledger status indicates ending operation of a distributed ledger corresponding to the ledger status, the processing circuitry deletes the distributed ledger.

7. The management device according to claim 2,
wherein the ledger status information includes a ledger status that indicates ending operation of a distributed ledger, and
wherein when the ledger status indicates ending operation of a distributed ledger corresponding to the ledger status, the processing circuitry deletes the distributed ledger.

8. The management device according to claim 3,
wherein the ledger status information includes a ledger status that indicates ending operation of a distributed ledger, and
wherein when the ledger status indicates ending operation of a distributed ledger corresponding to the ledger status, the processing circuitry deletes the distributed ledger.

9. The management device according to claim 4,
wherein the ledger status information includes a ledger status that indicates ending operation of a distributed ledger, and
wherein when the ledger status indicates ending operation of a distributed ledger corresponding to the ledger status, the processing circuitry deletes the distributed ledger.

10. The management device according to claim 5,
wherein the ledger status information includes a ledger status that indicates ending operation of a distributed ledger, and
wherein when the ledger status indicates ending operation of a distributed ledger corresponding to the ledger status, the processing circuitry deletes the distributed ledger.

11. A management method
wherein ledger status information including a ledger status is recorded, the ledger status indicating control restriction corresponding to an individual one of at least one distributed ledger which records distributed electronic data and to which control restriction is applied, the management method comprising accepting an operation instruction being an instruction to operate one of said at least one distributed ledger, and searching for a distributed ledger corresponding to a ledger status that indicates permitting a process corresponding to the operation instruction, from said at least one distributed ledger, and
controlling an individual one of said at least one distributed ledger in accordance with the ledger status corresponding to an individual one of said at least one distributed ledger.

12. A non-transitory computer-readable recording medium recorded with a management program which causes a computer
to record ledger status information including a ledger status indicating control restriction corresponding to an individual one of at least one distributed ledger which records distributed electronic data and to which control restriction is applied, to accept an operation instruction being an instruction to operate one of said at least one distributed ledger, and to search for a distributed ledger corresponding to a ledger status indicating permitting a process corresponding to the operation instruction, from said at least one distributed ledger; and
to control an individual one of said at least one distributed ledger in accordance with the ledger status corresponding to an individual one of said at least one distributed ledger.
